(19) United States
(12) Patent Application Publication
(10) Pub. No.: US 2007/0226453 A1
(43) Pub. Date: Sep. 27, 2007

(54) Method for improving processing of relatively aligned memory references for increased reuse opportunities

(76) Inventors: Alexandre E. Eichenberger, Chappaqua, NY (US); Rohini Nair, Kerala (IN); Kai-Ting Amy Wang, North York (CA); Peng Wu, Mount Kisco, NY (US); Peng Zhao, East York (CA)

Correspondence Address: DUKE W. YEE;YEE & ASSOCIATES, P.C., P.O. BOX 802333, DALLAS, TX, 75380, US

(21) Appl. No.: 11/387,218

(22) Filed: Mar. 23, 2006

(51) Int. Cl. G06F 15/00

(52) U.S. Cl. 712/6

(57) ABSTRACT

Computer implemented method, system and computer program product for aligning vectors to be processed by SIMD code. A pair of vectors to be aligned at runtime and having a known relative alignment at compile time is identified. A modified second memory reference is generated by modifying an address of the second memory reference to be in a same congruence class as the first memory reference, wherein the congruence class is mod V and wherein V is SIMD byte width. A first SIMD load located at the modified second memory reference and a next adjacent SIMD load located at a third memory reference corresponding to the modified second memory reference address plus V are loaded, and the first SIMD load and the next adjacent SIMD load are concatenated to generate a resultant vector of length 2V. The resultant vector is left shifted by an amount corresponding to a difference between the addresses of the first memory reference and the second memory reference mod V, and the leftmost V bytes of the resultant vector are retained to align the first and second vectors.

This invention was made with Government support under the National Security Agency, Contract No. H98230-04-C-0920. THE GOVERNMENT HAS CERTAIN RIGHTS IN THIS INVENTION.

### BACKGROUND OF THE INVENTION

1. Field of the Invention

The present invention relates generally to the data processing field and, more particularly, to a computer implemented method, system and computer program product for aligning vectors to be processed by SIMD code.

2. Description of the Related Art

Modern processors are using Single Issue Multiple Data (SIMD) units with greater frequency in order to significantly increase processing power without having to significantly increase issue bandwidth. Although SIMD units can be programmed by hand, especially for dedicated libraries and a small number of kernels, the performance impact of SIMD units will likely remain limited until compiler technology permits automatic generation of SIMD code, referred to hereinafter as “simdization”, for a wide range of applications.

The SIMD process is basically a set of operations that enables efficient handling of large quantities of data in parallel. FIG. 1 is a block diagram that schematically illustrates an exemplary SIMD computation to assist in providing a clear understanding of the simdization process. In this example, we assume 16-byte wide SIMD units; however, all presented techniques works for SIMD units of arbitrary width. In particular, FIG. 1 illustrates simultaneous processing of multiple “b[i]+c[i]” data, where the memory location storing b[i] is schematically represented as 102 and the memory location storing c[i] is schematically represented as 104. As shown, the memory locations are divided into 16 byte SIMD units separated by boundaries 106 and 108, respectively. As also shown in FIG. 1, the results of loading the data from memory using the SIMD load operations with respect to aligned 16 byte SIMD units results in the data b0, b1, b2, and b3 in register 110 and c0, c1, c2, and c3 in register 112. As shown in FIG. 1, the data in 110 and 112 are then added together using a single SIMD add operation and results in b0+c0, b1+c1, b2+c2 and b3+c3 as shown at 114.

In a non-simdized environment, for each iteration of a loop, the “b[i]+c[i]” data would have to be added individually. That is, the result of the first non-simdized operation would yield b0+c0, the result of the second would yield b1+c1, and so on. In contradistinction, as shown at 114, the result of one operation in the SIMD environment yields b0+c0, b1+c1, b2+c2 and b3+c3.

A problem that is encountered in connection with simdization relates to data alignment in that data does not properly align with system hardware. Current procedures for effecting data alignment tend to be rather complex and to require significant processing. This can be best understood by reference to the following example of a known alignment handling procedure for a simple code:

for(i=0; i<256; i++) {

a[i] = b[i] + b[i+1]

}

where it is assumed that all array bases are aligned at 16-byte boundaries. In the sample code noted above, the references “a” and “b” are each to a particular array, and the references “a[i]” and “b[i]” are to a specific address within array “a” and array “b”, respectively. Accordingly, there is misalignment between “b[i]” and “b[i+1]” (it is assumed that array “a” and array “b” are aligned relative to one another). This misalignment is shown in FIG. 2 which is a block diagram that schematically illustrates the SIMD alignment problem to assist in providing a clear understanding of the present invention. In particular, FIG. 2 illustrates the SIMD execution for a[0]=b[0]+b[1]. The memory location storing b[0] is represented as 202. The vector load operation, vload b[0] loads b[0] into vector 204, which has an offset of zero bytes. The memory location storing b[1] is represented as 206. Memory locations 202 and 206 are in fact the same memory location storing the same data; this memory location is depicted twice, once for each load, solely for visual clarity. The vector load operation, vload b[1] loads b[1] into vector 208, which has an offset of four bytes because b1 is not the first element in vector 208. A vector add operation, vadd, tries to add vectors 204 and 208 together. However, as shown at 210, the vadd operation does not result in the addition of b[0] to b[1] because b[1] is misaligned in vector 208 by four bytes.

In order to handle the misalignment of “b[i+1]” with respect to the 2 other references, a stream-shift operation is introduced as follows:

for(i=0; i<256; i+=4) {

a[i+0..3] = b[i+0..3] + shift-pair-

left(b[..i+1..], b[..i+1+4..], 4);

}

The notation “a[i+0 . . . 3]” is a contraction of “a[i+0, i+1, i+2, i+3], and this contracted notation will be used throughout this specification. The notation “i+=4” denotes the fact that the code segment above computes four values per iteration. Above, shift-pair-left(X, Y, offset) selects bytes offset, offset+1, . . . , offset+V−1 from a double-length vector constructed by concatenating A and B. V is the vector byte size, e.g. 16 bytes in this example. This misalignment correction is shown in FIG. 3 which is a block diagram that schematically illustrates correction of the SIMD alignment problem to assist in providing a clear understanding of the present invention. In particular, FIG. 3 illustrates the SIMD execution for a[0]=b[0]+b[1]. The memory location storing b[0] is represented as 302. The vector load operation, vload b[0] loads b[0] into vector 304, which has an offset of zero bytes. The memory location storing b[1] is represented as 306. Analogously to FIG. 2, memory locations 302 and 306 are in fact the same memory location storing the same data; this memory location is depicted twice, once for each load, solely for visual clarity. The vector load operation, vload b[1], loads b[1] into vector 308, which would normally cause an offset of four bytes in vector 308 because b1 is not the first element in vector 308. However, by applying stream-shift operation 312, stream-shift (4,0) to the vload operation, vloadb[1], the four byte offset is corrected and vector 308 becomes properly aligned with element b1 as the first element in the vector. A vector add operation, vadd, adds vectors 304 and 308 together. As shown by 310, the vadd operation is successful in adding b[0] to b[1] because the misalignment in vector 308 was corrected.

Consider the above example from the perspective of common subexpression elimination (CSE) or predictive commoning (PC). Since the alignment of array b is known, it is also known that vload(b[i+1]) is the same as vload(b[i+0]) because it is known that the non-aligning load truncates the last 4 bits of the address. This translates into truncating the offset in the array computation by a factor of 4. Thus, the above example can be rewritten truncating all the array computations by 4 as follows:

for(i=0; i<256; i+=4) {

a[i+0..3] = b[i+0..3] + shift-pair-left(b[i+0..3],
b[i+4..7], 4);

}

Predictive commoning is capable of seeing the reuse of the two “b[i+0 . . . 3]” and the reuse of the “b[i+4 . . . 7]” with the “b[i+0 . . . 3]” of the next iteration. As a result, the code would look as follows after predictive commoning:

b_old = b[0..3]
for(i=0; i<256; i+=4) {

b_new = b[i+4..7];
a[i+0..3] = b_old + shift-pair-left(b_old,
b_new, 4);
b_old = b_new;

}

It should be noted that there is a single load of array b that is used 3 times, 1 time in the current loop iteration and 2 times in the next iteration. Note also that the copy at the end of the loop trivially goes away with an unrolling of the loop by a multiple of 2.

Now consider this same example with a minor modification, namely with a runtime lower bound, denoted by “lb”:

for(i=lb; i<256; i++) {

a[i] = b[i] + b[i+1]

}

The code segment above is normalized as follows:

for(i=0; i<256-lb; i++) {

a[i+lb] = b[i+lb] + b[i+lb+1]

}

Because the actual runtime alignment is not known, the system would have to load three data sets on its first iteration. In particular, the system would have to issue a SIMD load of b[i+lb+1] and a SIMD load of b[i+lb+5], and then stream-shift these two vectors to generate the vector b[i+lb+1, i+lb+2, i+lb+3, i+lb+4]. Because the system cannot determine in advance the congruence class in which a particular instance of b[i+lb] and b[i+lb+1] will fall, we cannot eliminate one of the SIMD loads to b[i+lb] and b[i+lb+1].

Consider the example illustrated in FIGS. 4A and 4B. In particular, FIGS. 4A and 4B are block diagrams that schematically illustrate the effect of loading two different adjacent values when the absolute alignment of the two adjacent addresses are not known at compile time, and are intended to assist in providing a clear understanding of the present invention. Assuming the array base of b to be aligned (i.e., the address of b[0] is aligned at a multiple of 16 bytes in memory), FIG. 4A depicts the values loaded by a SIMD load for b[i+lb] and b[i+lb+1] during the first i=0 iteration when the value of lb is zero. From visual inspection of FIG. 4A, it can be seen that the values loaded by both SIMD loads result in the same b[0]. . . b[3] values in registers 404 and 406. FIG. 4B, however, assumes a different value for lb, namely 3. In this case, from visual inspection of FIG. 4B, it can be seen that the values loaded by a SIMD load for b[i+lb] and b[i+lb+1] during the first i=0 iteration are not the same. Indeed, the first SIMD load of b[i+lb] results in the values b[0]. . . b[3] in register 414 whereas the second SIMD load of b[i+lb+1] results in the values b[4]. . . b[7] in register 416.

As is apparent from FIGS. 4A and 4B, unless the precise alignment of the data being loaded by the SIMD unit is known, b[i+lb] and b[i+lb+1] in this example, it cannot be assumed that they will get the same data in the SIMD registers. In other words, because the alignment of the two loads is not known, it cannot be guaranteed that they will fall in the same congruence class modulo, the SIMD width of the SIMD hardware unit (referred to as V herein).

As seen above, the (absolute) alignment of all references are runtime, inasmuch as the value of lb is only known at runtime (in this example). The relative alignment of any two pairs of memory references, however, is known at compile time. Relative alignment is computed as the difference between two addresses mod V (V=16 on VMX/SPE).

Current robust alignment handling procedures, which are able to handle any combination of conversions and runtime alignments, proceed by 1) appropriately prepending bytes to the stream that needs to be shifted; and 2) shifting the prepended stream to offset zero. In the absence of conversions, the prepended amount is the actual alignment of the destination stream.

In particular, if it is desired to align a stream b[i+lb+1] with runtime alignment (lb+1)*4 mod 16 to the runtime alignment of a[i+lb], namely 4*lb mod 16, in the absence of conversions, the following is performed:
stream-shift(prepend(b[i+lb+1], 4*lb mod 16), 4, 0)=
stream-shift(b[i+lb+1−(4*lb mod 16)/4], 4, 0)=
stream-shift(b[i+lb+1−lb & 3], 4, 0)=
stream-shift(b[i+1+lb&!3], 4, 0)
   This stream-shift will translate in the following shift-pair-left:
shift-pair-left(b[i+1+lb&!3], b[i+5+lb&!3], 4)

Given that the other b[i+lb] is relatively aligned to a[i+lb], the following code is obtained for the example after simdization:

// prologue handling, skipped here for simplicity
for(i=0; i<256−lb; i+=4) {

a[...i+lb...] = b[...i+lb...] +

shift-pair-left (b[...i+1+1b&!3...],

b[...i+5+lb&!3...], 4)

}
// epilogue handling, skipped here for simplicity

From the perspective of CSE, the expression b[ . . . i+lb . . . ] and b[ . . . i+1+lb&!3 . . . ] cannot be commoned out, in general. This can be seen from the values in Table 1 wherein truncation occurs at different places depending on runtime ‘lb’:

TABLE 1

| | b[ . . . i + lb . . . ] | b[ . . . + 1 + lb&!3 . . . ] |
|---|---|---|
| lb = 0 | b[i + 0 . . . + 3] | b[i + 0 . . . + 3] |
| lb = 3 | b[i + 0 . . . + 3] | b[i + 4 . . . + 7] |

In addition, predictive commoning has difficulties seen in the reuse between b[ . . . i+1+lb&!3 . . . ] and b[ . . . i+5+lb&!3 . . . ]. Thus, in the presence of a runtime lower bound, the number of loads for the b memory streams increases from 1 (compile time lower bound) to 3.

### SUMMARY OF THE INVENTION

The present invention provides a computer implemented method, system and computer program product for aligning vectors to be processed by SIMD code. The method begins by identifying a pair of vectors to be aligned at runtime and having a known relative alignment at compile time. A modified second memory reference is generated by modifying an address of the second memory reference to be in a same congruence class as the first memory reference, wherein the congruence class is mod V and wherein V is SIMD byte width. A first SIMD load located at the modified second memory reference and a next adjacent SIMD load located at a third memory reference corresponding to the modified second memory reference address plus V are loaded, and the first SIMD load and the next adjacent SIMD load are concatenated to generate a resultant vector of length 2V. The resultant vector is left shifted by an amount corresponding to a difference between the addresses of the first memory reference and the second memory reference mod V, and the leftmost V bytes of the resultant vector are retained to align the first and second vectors.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a block diagram that schematically illustrates an exemplary SIMD computation to assist in providing a clear understanding of the simdization process;

FIG. 2 is a block diagram that schematically illustrates the SIMD alignment problem to assist in providing a clear understanding of the present invention;

FIG. 3 is a block diagram that schematically illustrates a correction of the SIMD alignment problem to assist in providing a clear understanding of the present invention;

FIGS. 4A and 4B are block diagrams that schematically illustrate the effect of loading two different adjacent values when the absolute alignment of the two adjacent addresses are not known at compile time to assist in providing a clear understanding of the present invention;

FIG. 5 depicts a pictorial representation of a network of data processing systems in which aspects of the present invention may be implemented;

FIG. 6 is a block diagram of a data processing system in which aspects of the present invention may be implemented; and

FIG. 7 is a flowchart that illustrates a method for aligning vectors to be processed by SIMD code according to an exemplary embodiment of the present invention.

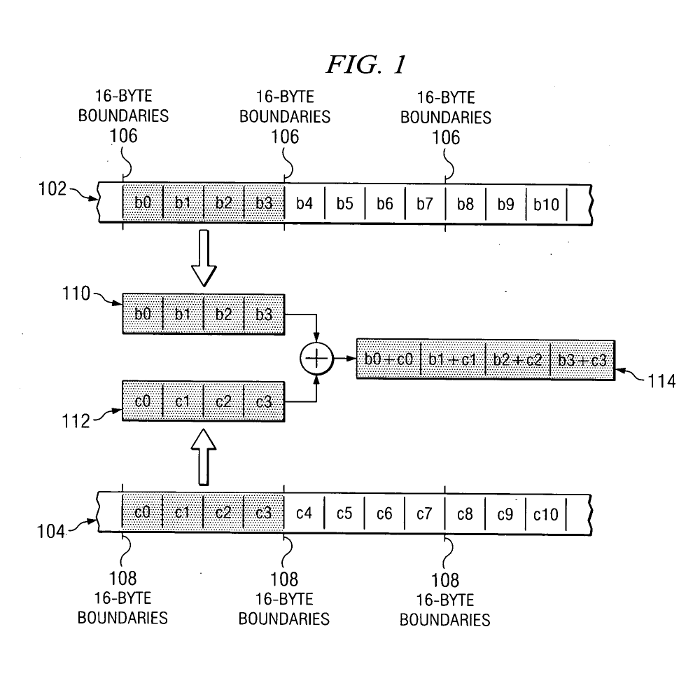

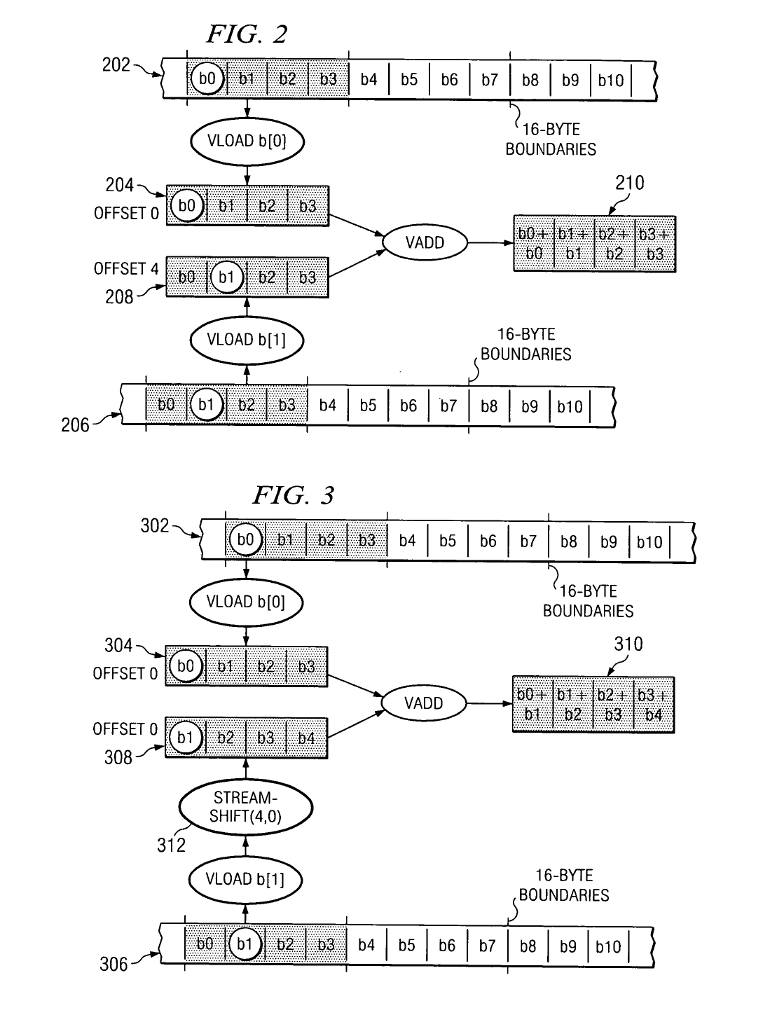

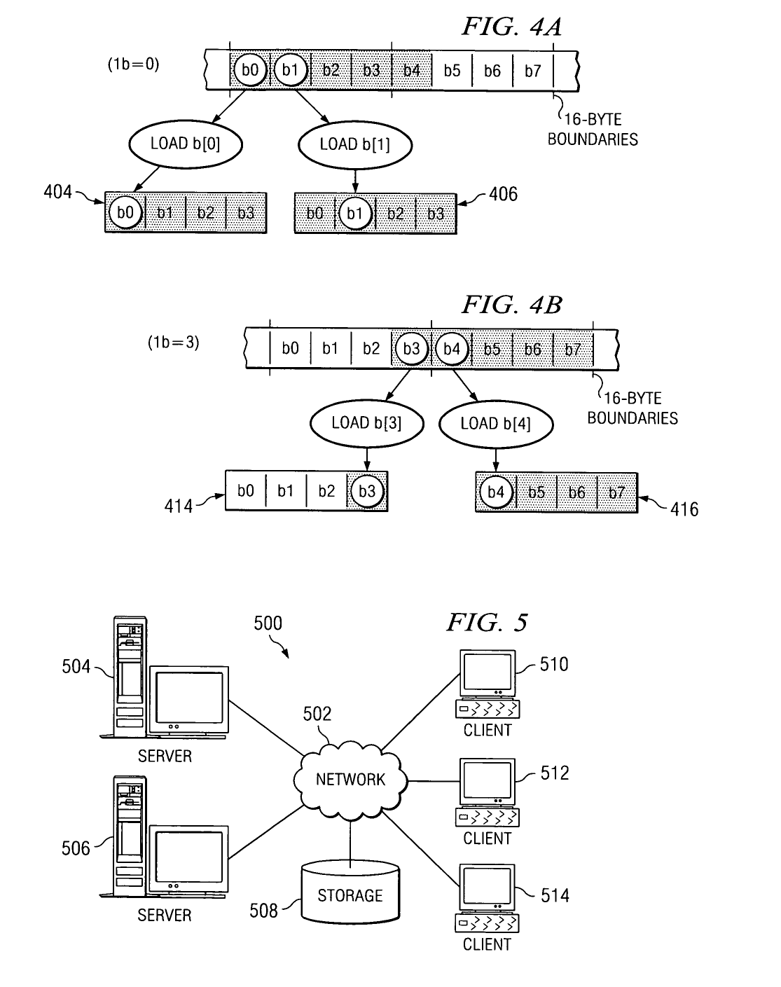

### DETAILED DESCRIPTION OF THE PREFERRED EMBODIMENT

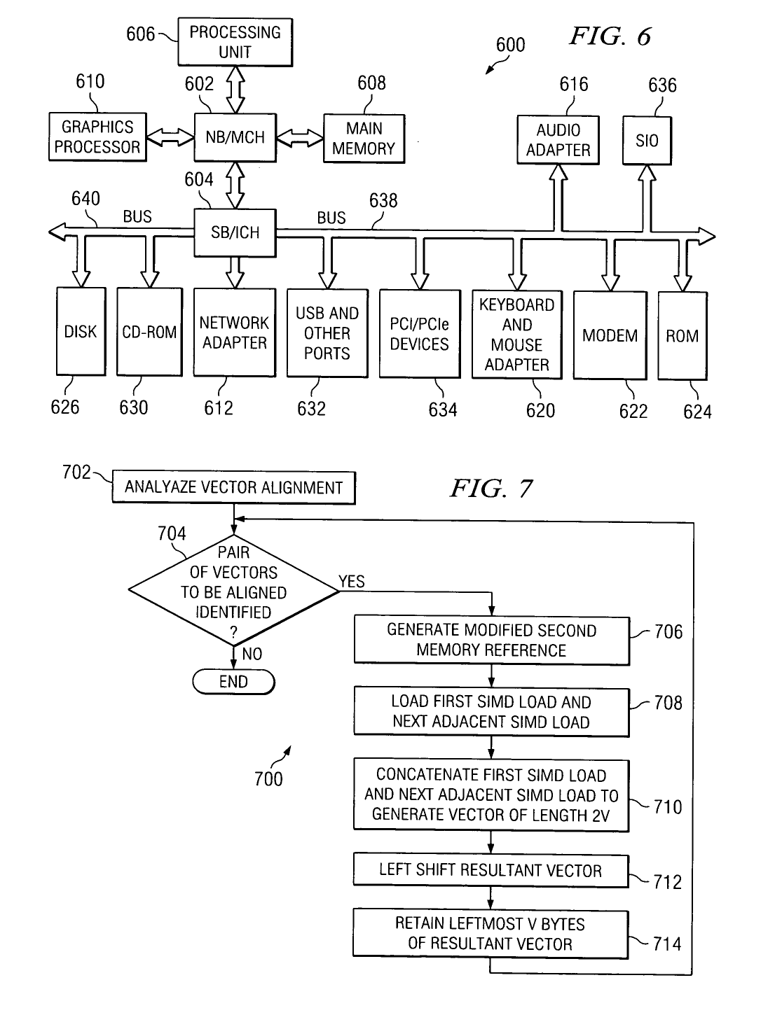

With reference now to the figures and in particular with reference to FIGS. 5-6, exemplary diagrams of data processing environments are provided in which embodiments of the present invention may be implemented. It should be appreciated that FIGS. 5-6 are only exemplary and are not intended to assert or imply any limitation with regard to the environments in which aspects or embodiments of the present invention may be implemented. Many modifications to the depicted environments may be made without departing from the spirit and scope of the present invention.

With reference now to the figures, FIG. 5 depicts a pictorial representation of a network of data processing systems in which aspects of the present invention may be implemented. Network data processing system 500 is a network of computers in which embodiments of the present invention may be implemented. Network data processing system 500 contains network 502, which is the medium used to provide communications links between various devices and computers coupled together within network data processing system 500. Network 502 may include connections, such as wire, wireless communication links, or fiber optic cables.

In the depicted example, server 504 and server 506 are coupled to network 502 along with storage unit 508. In addition, clients 510, 512, and 514 are coupled to network 502. These clients 510, 512, and 514 may be, for example, personal computers or network computers. In the depicted example, server 504 provides data, such as boot files, operating system images, and applications to clients 510, 512, and 514. Clients 510, 512, and 514 are clients to server 504 in this example. Network data processing system 500 may include additional servers, clients, and other devices not shown.

In the depicted example, network data processing system 500 is the Internet with network 502 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 500 also may be implemented as a number of different types of networks, such as for example, an intranet, a local area network (LAN), or a wide area network (WAN). FIG. 5 is intended as an example, and not as an architectural limitation for different embodiments of the present invention.

With reference now to FIG. 6, a block diagram of a data processing system is shown in which aspects of the present invention may be implemented. Data processing system 600 is an example of a computer, such as server 504 or client 510 in FIG. 5, in which computer usable code or instructions implementing the processes for embodiments of the present invention may be located.

In the depicted example, data processing system 600 employs a hub architecture including north bridge and memory controller hub (NB/MCH) 602 and south bridge and input/output (I/O) controller hub (SB/ICH) 604. Processing unit 606, main memory 608, and graphics processor 610 are coupled to NB/MCH 602. Graphics processor 610 may be coupled to NB/MCH 602 through an accelerated graphics port (AGP).

In the depicted example, local area network (LAN) adapter 612 is coupled to SB/ICH 604. Audio adapter 616, keyboard and mouse adapter 620, modem 622, read only memory (ROM) 624, universal serial bus (USB) ports and other communication ports 632, and PCI/PCIe devices 634 are coupled to SB/ICH 604 through bus 638, and hard disk drive (HDD) 626 and CD-ROM drive 630 are coupled to SB/ICH 604 through bus 640. PCI/PCIe devices may include, for example, Ethernet adapters, add-in cards, and PC cards for notebook computers. PCI uses a card bus controller, while PCIe does not. ROM 624 may be, for example, a flash binary input/output system (BIOS).

HDD 626 and CD-ROM drive 630 are coupled to SB/ICH 604 through bus 640. HDD 626 and CD-ROM drive 630 may use, for example, an integrated drive electronics (IDE) or serial advanced technology attachment (SATA) interface. Super I/O (SIO) device 636 may be coupled to SB/ICH 604.

An operating system runs on processing unit 606 and coordinates and provides control of various components within data processing system 600 in FIG. 6. As a client, the operating system may be a commercially available operating system such as Microsoft® Windows® XP (Microsoft and Windows are trademarks of Microsoft Corporation in the United States, other countries, or both). An object-oriented programming system, such as the Java programming system, may run in conjunction with the operating system and provides calls to the operating system from Java programs or applications executing on data processing system 600 (Java is a trademark of Sun Microsystems, Inc. in the United States, other countries, or both).

As a server, data processing system 600 may be, for example, an IBM® eServer™ pSeries® computer system, running the Advanced Interactive Executive (AIX®) operating system or the LINUX® operating system (eServer, pSeries and AIX are trademarks of International Business Machines Corporation in the United States, other countries, or both while LINUX is a trademark of Linus Torvalds in the United States, other countries, or both). Data processing system 600 may be a symmetric multiprocessor (SMP) system including a plurality of processors in processing unit 606. Alternatively, a single processor system may be employed.

Instructions for the operating system, the object-oriented programming system, and applications or programs are located on storage devices, such as HDD 626, and may be loaded into main memory 608 for execution by processing unit 606. The processes for embodiments of the present invention are performed by processing unit 606 using computer usable program code, which may be located in a memory such as, for example, main memory 608, ROM 624, or in one or more peripheral devices 626 and 630.

Those of ordinary skill in the art will appreciate that the hardware in FIGS. 5-6 may vary depending on the implementation. Other internal hardware or peripheral devices, such as flash memory, equivalent non-volatile memory, or optical disk drives and the like, may be used in addition to or in place of the hardware depicted in FIGS. 5-6. Also, the processes of the present invention may be applied to a multiprocessor data processing system.

In some illustrative examples, data processing system 600 may be a personal digital assistant (PDA), which is configured with flash memory to provide non-volatile memory for storing operating system files and/or user-generated data.

A bus system may be comprised of one or more buses, such as bus 638 or bus 640 as shown in FIG. 6. Of course, the bus system may be implemented using any type of communication fabric or architecture that provides for a transfer of data between different components or devices attached to the fabric or architecture. A communication unit may include one or more devices used to transmit and receive data, such as modem 622 or network adapter 612 of FIG. 6. A memory may be, for example, main memory 608, ROM 624, or a cache such as found in NB/MCH 602 in FIG. 6. The depicted examples in FIGS. 5-6 and above-described examples are not meant to imply architectural limitations. For example, data processing system 600 also may be a tablet computer, laptop computer, or telephone device in addition to taking the form of a PDA.

The present invention provides a computer implemented method, system and computer program product for aligning vectors to be processed by SIMD code. A system of the present invention may be implemented in a processor, such as processing unit 606 in data processing system 600 illustrated in FIG. 6.

A problem with the known alignment processing approach described previously occurs in connection with the “+1” in the two b[i+lb] and b[i+lb+1] references. In accordance with exemplary embodiments of the present invention, it is recorded that the two addresses are 4 bytes apart, and then load in both cases b[i+lb] and shift that value by 4 bytes to get the second stream. In other words, the addresses are normalized aggressively, even in the presence of runtime alignment, and then the normalization step is corrected by shifting the loaded values. The objective is to make sure that the truncation that occurs in the load (as seen in Table 1) occurs at the same value of lb (or whatever makes the alignment runtime alignment).

As will become apparent hereinafter, the present invention may significantly reduce the number of memory references in real code, which can result in a significant speedup when executing.

In order to provide a clear understanding of aspects of the present invention, the following example is provided. In particular, consider two references A[i+X+Oa] and B[i+X+Ob] where X is some runtime variable and Oa and Ob are compile time offsets. Assume that it is desired to align the B array stored at the reference to the alignment of the A array stored at the reference. Assuming the arrays are aligned and are arrays of integers, the alignments of A and B are, respectively, 4(X+Oa) mod 16 and 4(X+Ob) mod 16. Their relative alignment is 4(Ob−Oa) mod 16.

For statements without conversions, and with relative alignment known at compile time, the following may be done to align B to the alignment of A:
deltaBA=(addr(B)−addr(A)) mod V (must be constant)
   then shifting is performed as follows:
shift-pair-left(addr(B)−deltaBA, addr(B)−deltaBA+16, deltaBA)

Using the above value for references A and B provides:
deltaBA=4(Ob−Oa) mod 16 shift-pair-left(B[X+Ob−(Ob−Oa)mod4)],
B[X+Ob−(Ob−Oa)mod4)+4],
4(Ob−Oa) mod 16)
   and recalling that since Oa and Ob are compile time constant, compile time constant is only added to the B references here.

Assuming Oa=0, consider a few values for Ob as shown in Table 2:

TABLE 2

| | B[ . . . X + Ob − | B[ . . . X + Ob − | |
|---|---|---|---|
| (Oa = 0) | (Ob mod4) . . . ] | (Ob mod4) + 4 . . . ] | shift by |
| Ob = 0 | B[ . . . X + 0 . . . ] | B[ . . . X + 4 . . . ] | 0 |
| Ob = 1 | B[ . . . X + 0 . . . ] | B[ . . . X + 4 . . . ] | 4 |
| Ob = 5 | B[ . . . X + 4 . . . ] | B[ . . . X + 8 . . . ] | 4 |
| Ob = −1 | B[ . . . X − 4 . . . ] | B[ . . . X + 0 . . . ] | 12 |

It can be seen that no matter the value of Ob, only compile time multiples of 4 are added to/subtracted from the addresses of B, which makes it very easy for the compiler to detect redundancy in the address streams.

Assuming Oa=7, consider a few values for Ob as shown in Table 3:

TABLE 3

| | B[ . . . X + Ob − | B[ . . . X + Ob − | shift |
|---|---|---|---|
| (Oa = 7) | (Ob − 7) mod4 . . . ] | (Ob − 7) mod4 + 4 . . . ] | by |
| Ob = 0 | B[ . . . X − 1 . . . ] | B[ . . . X + 3 . . . ] | 4 |
| Ob = 1 | B[ . . . X − 1 . . . ] | B[ . . . X + 3 . . . ] | 8 |
| Ob = 5 | B[ . . . X + 3 . . . ] | B[ . . . X + 7 . . . | 8 |
| Ob = −1 | B[ . . . X − 1 . . . ] | B[ . . . X + 3 . . . ] | 0 |

Again it can be seen that regardless of the value only compile time multiples of 4 are added/subtracted to the address of B.

Accordingly, using this new formula in the example, the following is obtained after simdization:

// prologue handling, skipped here for simplicity
for(i=0; i<256−lb; i+=4) {

a[...i+lb...] = b[...i+lb...] +

shift-pair-left (b[...i+lb+0...],

b[...i+lb+4...], 4)

}
// epilogue handling, skipped here for simplicity

In this example, predictive commoning succeeds in collapsing all b references to a single one, as below:

// prologue handling, skipped here for simplicity
b_old = b[...i+lb...]
for(i=0; i<256−lb; i+=4) {

b_new = b[...i+lb+4...]
a[...i+lb...] = b_old +

shift-pair-left (b_old, b_new, 4)

}
// epilogue handling, skipped here for simplicity

FIG. 7 is a flowchart that illustrates a method for aligning vectors to be processed by SIMD code according to an exemplary embodiment of the present invention. The method is generally designated by reference number 700, and begins by analyzing vector alignment in order to identify a pair of vectors to be aligned at runtime (Step 702). A determination is made whether a pair of vectors to be aligned at runtime is identified (Step 704). For example, the pair of vectors may comprise a first vector that is stored at a first memory reference and a second vector that is stored at a second reference in which the first and second memory references have a known relative alignment at compile time. According to an exemplary embodiment of the invention, a beneficial pair of memory vectors is identified by a mechanism that attempts to maximize reuse opportunities and minimize stream shift overhead required by SIMD code generation.

If a pair of vectors to be aligned at runtime is identified (Yes output of Step 704), a modified second memory reference is generated by modifying an address of the second memory reference to be in a same congruence class as the first memory reference, wherein the congruence class is mod V and wherein V is SIMD byte width (Step 706). A first SIMD load located at the modified second memory reference and a next adjacent SIMD load located at a third memory reference corresponding to the modified second memory reference address plus V are loaded (Step 708), and the first SIMD load and the next adjacent SIMD load are concatenated to generate a resultant vector of length 2V (Step 710). The resultant vector is left shifted by an amount corresponding to a difference between the addresses of the first memory reference and the second memory reference mod V (Step 712), and the leftmost V bytes of the resultant vector are retained to align the first and second vectors(Step 714). According to an exemplary embodiment of the invention, the step of left shifting the resultant vector by an amount corresponding to a difference between the addresses of the first memory reference and the second memory reference mod V is accomplished by concatenating each of V bytes of data initially loaded from the modified address of the second memory reference and from the loaded modified second memory address plus V of the third memory reference for obtaining a 2*V bytes of concatenated data. A number of bytes that corresponds to a difference between the addresses of the first and second memory reference addresses mod V from a beginning of the concatenated data are discarded, keeping the next V bytes from the concatenated data. The remaining data in the concatenated data is also discarded such that the kept V bytes from the concatenated data corresponds to desired data from the second memory reference, and are properly aligned with the first memory reference.

The method then returns to Step 704 to determine whether another pair of vectors to be aligned at runtime and having a known relative alignment at compile time is identified, and if so, the method is repeated. If no further pairs of vectors are identified (No output of Step 704), the method ends.

The present invention thus provides a computer implemented method, system and computer program product for aligning vectors to be processed by SIMD code. The method begins by identifying a pair of vectors to be aligned at runtime and having a known relative alignment at compile time. A modified second memory reference is generated by modifying an address of the second memory reference to be in a same congruence class as the first memory reference, wherein the congruence class is mod V and wherein V is SIMD byte width. A first SIMD load located at the modified second memory reference and a next adjacent SIMD load located at a third memory reference corresponding to the modified second memory reference address plus V are loaded, and the first SIMD load and the next adjacent SIMD load are concatenated to generate a resultant vector of length 2V. The resultant vector is left shifted by an amount corresponding to a difference between the addresses of the first memory reference and the second memory reference mod V, and the leftmost V bytes of the resultant vector are retained to align the first and second vectors.

The invention can take the form of an entirely software embodiment, or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for aligning vectors to be processed by SIMD code, the computer implemented method comprising:
identifying a pair of vectors to be aligned at runtime, the pair of vectors comprising a first vector stored at a first memory reference and a second vector stored at a second memory reference, the first memory reference and the second memory reference having a known relative alignment at compile time;
generating a modified second memory reference by modifying an address of the second memory reference to be in a same congruence class as the first memory reference, wherein the congruence class is mod V and wherein V is SIMD byte width;
loading a first SIMD load located at the modified second memory reference and a next adjacent SIMD load located at a third memory reference corresponding to the modified second memory reference address plus V;
concatenating the first SIMD load and the next adjacent SIMD load to generate a resultant vector of length 2V;
left shifting the resultant vector by an amount corresponding to a difference between the addresses of the first memory reference and the second memory reference mod V; and
retaining the leftmost V bytes of the resultant vector.

2. The computer implemented method according to claim 1, and further comprising:
repeating the steps of identifying, generating, loading, concatenating, left-shifting and retaining until no further pairs of vectors to be aligned at runtime and comprising a first vector stored at a first memory reference and a second vector stored at a second memory reference, the first memory reference and the second memory reference having a known relative alignment at compile time, are identified.

3. The computer implemented method according to claim 1, wherein identifying a pair of vectors to be aligned at runtime the pair of vectors comprising a first vector stored at a first memory reference and a second vector stored at a second memory reference, the first memory reference and the second memory reference having a known relative alignment at compile time, comprises:
identifying a beneficial pair of memory vectors by a mechanism that attempts to maximize reuse opportunities and minimize stream shift overhead required by SIMD code generation.

4. The computer implemented method according to claim 1, wherein generating a modified second memory reference by modifying an address of the second memory address to be in a same congruence class as the first memory reference, wherein the congruence class is mod V and wherein V is SIMD byte width, comprises:
subtracting a difference of the addresses of the first memory reference and the second memory reference mod V.

5. The computer implemented method according to claim 1, wherein left shifting the resultant vector by an amount corresponding to a difference between the addresses of the first memory reference and the second memory reference mod V, comprises:
concatenating each of V bytes of data initially loaded from the modified address of the second memory reference and from the loaded modified second memory address plus V of the third memory reference for obtaining a 2*V bytes of concatenated data;
discarding a number of bytes from a beginning of the concatenated data, wherein the number of discarded bytes corresponds to a difference between the addresses of the first and second memory reference addresses mod V;
keeping a next V bytes from the concatenated data; and
discarding remaining data in the concatenated data, wherein the kept V bytes from the concatenated data corresponds to desired data from the second memory reference, and are properly aligned with the first memory reference.

6. The computer implemented method according to claim 1, wherein at least one of the pair of vectors to be aligned at runtime, and comprising a first vector stored at a first memory reference and a second vector stored at a second memory reference, the first memory reference and the second memory reference having a known relative alignment at compile time, comprises an expression corresponding to computations on at least one memory reference, and wherein all memory references within that expression have the same relative alignment.

7. The computer implemented method according to claim 6, and further comprising:
subtracting all addresses present in the expression of the second vector in the pair of vectors, and
shifting the expression of the second vector only once.

8. A computer program product, comprising:
a computer usable medium having computer usable program code configured for aligning vectors to be processed by SIMD code, the computer program product comprising:
computer usable program code configured for identifying a pair of vectors to be aligned at runtime, the pair of vectors comprising a first vector stored at a first memory reference and a second vector stored at a second memory reference, the first memory reference and the second memory reference having a known relative alignment at compile time;
computer usable program code configured for generating a modified second memory reference by modifying an address of the second memory reference to be in a same congruence class as the first memory reference, wherein the congruence class is mod V and wherein V is SIMD byte width;
computer usable program code configured for loading a first SIMD load located at the modified second memory reference and a next adjacent SIMD load located at a third memory reference corresponding to the modified second memory reference address plus V; and
computer usable program code configured for concatenating the first SIMD load and the next adjacent SIMD load to generate a resultant vector of length 2V;,
computer usable program code configured for left shifting the resultant vector by an amount corresponding to a difference between the addresses of the first memory reference and the second memory reference mod V; and
computer usable program code configured for retaining the leftmost V bytes of the resultant vector.

9. The computer program product according to claim 8, and further comprising:
computer usable program code configured for repeating the steps of identifying, generating, loading, concatenating, left-shifting and retaining until no further pairs of vectors to be aligned at runtime and comprising a first vector stored at a first memory reference and a second vector stored at a second memory reference, the first memory reference and the second memory reference having a known relative alignment at compile time, are identified.

10. The computer program product according to claim 8, wherein the computer usable program code configured for identifying a pair of vectors to be aligned at runtime, the pair of vectors comprising a first vector stored at a first memory reference and a second vector stored at a second memory reference, the first memory reference and the second memory reference having a known relative alignment at compile time, comprises:
computer usable program code configured for identifying a beneficial pair of memory vectors by a mechanism that attempts to maximize reuse opportunities and minimize stream shift overhead required by SIMD code generation.

11. The computer program product according to claim 8, wherein the computer usable program code configured for generating a modified second memory reference by modifying an address of the second memory address to be in a same congruence class as the first memory reference, wherein the congruence class is mod V and wherein V is SIMD byte width, comprises:
computer usable program code configured for subtracting a difference of the addresses of the first memory reference and the second memory reference mod V.

12. The computer program product according to claim 8, wherein the computer usable program code configured for left shifting the resultant vector by an amount corresponding to a difference between the addresses of the first memory reference and the second memory reference mod V comprises:
computer usable program code configured for concatenating each of V bytes of data initially loaded from the modified address of the second memory reference and from the loaded modified second memory address plus V of the third memory reference for obtaining a 2*V bytes of concatenated data;
computer usable program code configured for discarding a number of bytes from a beginning of the concatenated data, wherein the number of discarded bytes corresponds to a difference between the addresses of the first and second memory reference addresses mod V;
computer usable program code configured for keeping a next V bytes from the concatenated data; and
computer usable program code configured for discarding remaining data in the concatenated data, wherein the kept V bytes from the concatenated data corresponds to desired data from the second memory reference, and are properly aligned with the first memory reference.

13. The computer program product according to claim 8, wherein at least one of the pair of vectors to be aligned at runtime, and comprising a first vector stored at a first memory reference and a second vector stored at a second memory reference, the first memory reference and the second memory reference having a known relative alignment at compile time, comprises an expression corresponding to computations on at least one memory reference, and wherein all memory references within that expression have the same relative alignment, and wherein the computer program product further comprises:
computer usable program code configured for subtracting all addresses present in the expression of the second vector in the pair of vectors, and
computer usable program code configured for shifting the expression of the second vector only once.

14. A system for aligning vectors to be processed by SIMD code, comprising:
a mechanism for identifying a pair of vectors to be aligned at runtime, the pair of vectors comprising a first vector stored at a first memory reference and a second vector stored at a second memory reference, the first memory reference and the second memory reference having a known relative alignment at compile time;
a mechanism for generating a modified second memory reference by modifying an address of the second memory reference to be in a same congruence class as the first memory reference, wherein the congruence class is mod V and wherein V is SIMD byte width;
a mechanism for loading a first SIMD load located at the modified second memory reference and a next adjacent SIMD load located at a third memory reference corresponding to the modified second memory reference address plus V;
a mechanism for concatenating the first SIMD load and the next adjacent SIMD load to generate a resultant vector of length 2V;
a mechanism for left shifting the resultant vector by an amount corresponding to a difference between the addresses of the first memory reference and the second memory reference mod V; and
a mechanism for retaining the leftmost V bytes of the resultant vector.

15. The system according to claim 14, and further comprising:
a mechanism for repeating the steps of identifying, generating, loading, concatenating, left-shifting and retaining until no further pairs of vectors to be aligned at runtime, and comprising a first vector stored at a first memory reference and a second vector stored at a second memory reference, the first memory reference and the second memory reference having a known relative alignment at compile time, are identified.

16. The system according to claim 14, wherein the mechanism for identifying a pair of vectors to be aligned at runtime, the pair of vectors comprising a first vector stored at a first memory reference and a second vector stored at a second memory reference, the first memory reference and the second memory reference having a known relative alignment at compile time, comprises:
a mechanism for identifying a beneficial pair of memory vectors by a mechanism that attempts to maximize reuse opportunities and minimize stream shift overhead required by SIMD code generation.

17. The system according to claim 14, wherein the mechanism for generating a modified second memory reference by modifying an address of the second memory reference to be in a same congruence class as the first memory reference, wherein the congruence class is mod V and wherein V is SIMD byte width, comprises:
a mechanism for subtracting a difference of the addresses of the first memory reference and the second memory reference mod V.

18. The system according to claim 14, wherein the mechanism for left shifting the resultant vector by an amount corresponding to a difference between the addresses of the first memory reference and the second memory reference mod V, comprises:
a mechanism for concatenating each of V bytes of data initially loaded from the modified address of the second memory reference and from the loaded modified second memory address plus V of the third memory reference for obtaining a 2*V bytes of concatenated data;
a mechanism for discarding a number of bytes from a beginning of the concatenated data, wherein the number of discarded bytes corresponds to a difference between the addresses of the first and second memory reference addresses mod V;
a mechanism for keeping a next V bytes from the concatenated data; and
a mechanism for discarding remaining data in the concatenated data, wherein the kept V bytes from the concatenated data corresponds to desired data from the second memory reference, and are properly aligned with the first memory reference.

19. The system according to claim 14, wherein at least one of the pair of vectors to be aligned at runtime, the pair of vectors comprising a first vector stored at a first memory reference and a second vector stored at a second memory reference, the first memory reference and the second memory reference having a known relative alignment at compile time, comprises an expression corresponding to computations on at least one memory reference, and wherein all memory references within that expression have the same relative alignment.

20. The system according to claim 19, and further comprising:
a mechanism for subtracting all addresses present in the expression of the second vector in the pair of vectors, and
a mechanism for shifting the expression of the second vector only once.
